(19) United States
(12) Patent Application Publication
(10) Pub. No.: US 2009/0245863 A1
(43) Pub. Date: Oct. 1, 2009

(54) DEVELOPING DEVICE AND IMAGE FORMING APPARATUS EQUIPPED WITH THE DEVELOPING DEVICE

(75) Inventors: Makoto SATO, Matsumoto-shi (JP); Katsumi OKAMOTO, Azumino-shi (JP); Koji MIGITA, Matsumoto-shi (JP); Takeshi AOKI, Matsumoto-shi (JP); Masashi NAKATSU, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/413,388

(22) Filed: Mar. 27, 2009

(30) Foreign Application Priority Data
Mar. 31, 2008 (JP) 2008-089035
Mar. 31, 2008 (JP) 2008-089036
Mar. 31, 2008 (JP) 2008-089037

(51) Int. Cl. G03G 15/08

(52) U.S. Cl. 399/120

(57) ABSTRACT

A developing device includes: a replaceable toner cartridge; a development chamber; a first transport path which connects the toner cartridge to the development chamber; a first transport unit which transports toner from the toner cartridge to the development chamber through the first transport path; a second transport path which connects the development chamber to the toner cartridge; and a second transport unit which discharges the toner within the development chamber to the toner cartridge through the second transport path at the time of replacement of the toner cartridge.

The present invention contains subject matter related to Japanese Patent Application No. 2008-089035 filed in the Japanese Patent Office on Mar. 31, 2008, Japanese Patent Application No. 2008-089036 filed in the Japanese Patent Office on Mar. 31, 2008, and Japanese Patent Application No. 2008-089037 filed in the Japanese Patent Office on Mar. 31, 2008, the entire contents of which are incorporated herein by reference.

### BACKGROUND

1. Technical Field

The present invention relates to a developing device which develops electrostatic latent image on a latent image carrier with a developer and an image forming apparatus equipped with the developing device.

2. Related Art

An electrophotographic recording type image forming apparatus which forms an electrostatic latent image based on image data on a surface of a latent image carrier by exposure has been known. In the image forming apparatus, an image is formed by developing the electrostatic latent image with toner by a developing device and transferring the toner image on the surface of the latent image carrier onto a recording medium, such as recording paper. In recent years, such type of image forming apparatus is generally designed such that a toner cartridge, which is formed as one body with a developing device or separately from the developing device and which contains toner therein, is detachably mounted. When the contained toner is consumed by repeatedly developing an electrostatic latent image on a surface of a latent image carrier, toner for developing the electrostatic latent image on the surface of the latent image carrier is filled up by replacing the toner cartridge.

In such a developing device, the charging ability of toner deteriorates since the toner in a development chamber is stirred for a long time by a stirring member, a toner supply roller, and a regulation blade. When new toner and deteriorated toner remaining in the development chamber are used in a state where the new toner and the deteriorated toner are stirred to be mixed in the development chamber by replacement of a toner cartridge, the new toner with the high charging ability is selectively charged and charging of the deteriorated toner becomes insufficient. As a result, since the charged amount of the whole toner which is stirred to be mixed is not sufficient, regulation passing failure and adhesion (fogging) onto a non-image area occur. In order to prevent this, for example, JP-A-2000-181216 discloses a technique of disposal of toner remaining in a development chamber. In this technique, a driving time of a developing device is counted, forcible writing is performed in a non-image area according to the driving time, and toner, of which the charging ability is deteriorated, within the development chamber is consumed.

However, in the known techniques of disposal of the deteriorated toner within the development chamber, since the deteriorated toner is disposed of by counting a driving time of a developing device and performing forcible writing in a non-image area according to the driving time, the control is complicate, and devices other than the developing device should be driven for the processing of the deteriorated toner. As a result, problems arise in that large electric power is consumed for the processing of the deteriorated toner and the processing takes long time.

### SUMMARY

An advantage of some aspects of the invention is that it provides a developing device which is able to shorten the processing time and to prevent mixing of the new toner with the deteriorated toner by making disposal of the deteriorated toner within the development chamber easy with a simple configuration, and an image forming apparatus equipped with the developing device.

According to a first aspect of the invention, a developing device includes: a replaceable toner cartridge; a development chamber; a first transport path which connects the toner cartridge to the development chamber; a first transport unit which transports toner from the toner cartridge to the development chamber through the first transport path; a second transport path which connects the development chamber to the toner cartridge; and a second transport unit which discharges the toner within the development chamber to the toner cartridge through the second transport path at the time of replacement of the toner cartridge. With such a configuration, it is possible to discharge the residual-deteriorated toner within the development chamber at a periodic timing, that is, at the time of replacement of the toner. Therefore, it is possible to dispose of the toner remaining in the development chamber before the toner is extremely deteriorated, and it is possible to largely reduce occurrence of fogging and regulation passing failure caused by mixing with the new toner. Furthermore, it is possible to effectively use the vacant toner cartridge without being required to provide a separate container for containing the deteriorated toner since the discharged deteriorated toner is housed in the vacant toner cartridge.

In the developing device according to this aspect of the invention, it is preferable that the first transport unit and the second transport unit be driven separately. With such a configuration, it is possible to prevent mixing of the new toner with the residual-deteriorated toner at the time of discharge of the residual-deteriorated toner within the development chamber.

In the developing device according to this aspect of the invention, it is preferable that the second transport unit be driven only at the time of replacement of the toner cartridge. Since the second transport unit is driven only at the time of discharge of the residual-deteriorated toner, it is possible to save electric power consumption for disposal of the deteriorated toner.

In the developing device according to this aspect of the invention, it is preferable that the second transport unit be driven until the toner within the development chamber reaches the bottom of the development chamber. Since discharge of the deteriorated toner is terminated in a state where the deteriorated toner exists in the second transport path, it is possible to shorten a time of disposal of the deteriorated toner.

In the developing device according to this aspect of the invention, it is preferable that a developing roller and a toner supply roller be disposed in the development chamber, and it is also preferable that a driving unit which enables the toner supply roller to rotate forward or reverse be disposed therein. With such a configuration, it is possible to select a rotation direction at the time of printing or a rotation direction at the time of collection of the deteriorated toner.

According to a second aspect of the invention, an image forming apparatus includes: a latent image carrier which is rotatably provided and on which an electrostatic latent image is formed; a developing device which develops the electrostatic latent image with a developer to form a toner image on the latent image carrier; a transfer unit which transfers the toner image on the latent image carrier onto a transfer material; and a fixing unit which fixes the toner image on the transfer material. In the image forming apparatus, the above-mentioned developing device is mounted as the developing device. With such a configuration, it is possible to collect the deteriorated toner within the development chamber in the vacant toner cartridge at the time of replacement of the toner cartridge. As a result, it is possible to prevent image deterioration caused by mixing of the new toner with the residual-deteriorated toner.

According to a third aspect of the invention, a developing device includes: a replaceable toner cartridge; a development chamber; a first transport path which connects the toner cartridge to the development chamber; a first transport unit which transports new toner from the toner cartridge to the development chamber through the first transport path; a second transport path which connects the development chamber to a deteriorated toner collecting section; and a second transport unit which discharges the toner within the development chamber to the deteriorated toner collecting section through the second transport path under a predetermined condition. With such a configuration, it is possible to discharge the deteriorated toner within the development chamber to the deteriorated toner collecting section under the predetermined condition. Therefore, it is possible to dispose of the toner remaining in the development chamber before the toner is extremely deteriorated. As a result, it is possible to largely reduce occurrence of fogging and regulation passing failure caused by mixing with the new toner.

In the developing device according to this aspect of the invention, it is preferable that the predetermined condition be that the toner cartridge is replaced. With such a configuration, it is possible to discharge the residual-deteriorated toner within the development chamber at a periodic timing, that is, at the time of replacement of the toner.

In the developing device according to this aspect of the invention, it is preferable that the predetermined condition is that printing with a low image occupancy ratio be continuously performed for a predetermined time or more or be continuously performed on a predetermined number or more of sheets. With such a configuration, remaining of toner in the development chamber for a long time, that is, the condition of deterioration of the toner within the development chamber is set as the predetermined condition. As a result, it is possible to dispose of the deteriorated toner at a desirable timing.

In the developing device according to this aspect of the invention, it is preferable that the predetermined condition be that a high image quality mode or a cleaning mode is selected. With such a configuration, the high image quality mode in which it is preferable to use new toner or the cleaning mode in which image formation is not performed is set as the predetermined condition. As a result, it is possible to dispose of the deteriorated toner at a desirable timing.

In the developing device according to this aspect of the invention, it is preferable that the deteriorated toner collecting section be formed as a variable capacity space separated from a new toner containing section in the toner cartridge. With such a configuration, it is possible to effectively use a vacant space of the toner cartridge by preventing mixing of the deteriorated toner with the new toner, and it is possible to suppress the dedicated space for discharging the deteriorated toner. As a result, it is possible to downsize the apparatus.

In the developing device according to this aspect of the invention, it is preferable that the deteriorated toner collecting section be formed as a waste toner bottle. With such a configuration, it is possible to discharge the deteriorated toner at any time by disposing the waste toner bottle suitable for a discharge capacity of the deteriorated toner.

In the developing device according to this aspect of the invention, it is preferable that the second transport path be divided into a transport path for connecting to the deteriorated toner collecting section within the toner cartridge and a transport path for connecting to the waste toner bottle. With such a configuration, it is possible to increase a containing capacity of the deteriorated toner by employing two deteriorated toner collecting sections. As a result, it is possible to execute discharge of the deteriorated toner at any time.

According to a fourth aspect of the invention, an image forming apparatus includes: a latent image carrier which is rotatably provided and on which an electrostatic latent image is formed; a developing device which develops the electrostatic latent image with a developer to form a toner image on the latent image carrier; a transfer unit which transfers the toner image on the latent image carrier onto a transfer material; and a fixing unit which fixes the toner image on the transfer material. In the image forming apparatus, the above-mentioned developing device is mounted as the developing device. With such a configuration it is possible to prevent image deterioration caused by mixing of the new toner with the residual-deteriorated toner.

According to a fifth aspect of the invention, a developing device includes: a replaceable toner cartridge; a development chamber; a first transport path which connects the toner cartridge to the development chamber; a first transport unit which transports toner from the toner cartridge to the development chamber through the first transport path; a second transport path which connects the development chamber to the toner cartridge; and a second transport unit which transports the toner from the development chamber to the toner cartridge through the second transport path. The toner is circulated by driving the first and second transport units. All deteriorated toner within the development chamber and the second transport path is discharged to the toner cartridge at the time of replacement of the toner cartridge. With such a configuration, it is possible to discharge the residual-deteriorated toner within the development chamber when toner is deteriorated. Therefore, it is possible to dispose of the toner remaining in the development chamber before the toner is extremely deteriorated, and it is possible to largely reduce occurrence of fogging and regulation passing failure caused by mixing with the new toner. Furthermore, it is possible to effectively use the vacant toner cartridge without being required to provide a separate container for containing the deteriorated toner since the discharged deteriorated toner is housed in the vacant toner cartridge.

In addition, by circulating the toner all the time, it is possible to uniform toner deterioration, and it is possible to reduce the number of toner refresh operation.

In the developing device according to this aspect of the invention, it is preferable that transport of the toner from the first transport path be stopped to discharge the toner within the development chamber to the toner cartridge when printing with a low image occupancy ratio is continuously performed for a predetermined time or more or is continuously performed on a predetermined number or more of sheets before replacement of the toner cartridge. With such a configuration, remaining of toner in the development chamber for a long time, that is, the condition of deterioration of the toner within the development chamber is set as the refresh condition. As a result, it is possible to dispose of the deteriorated toner at a desirable timing. In addition, it is possible to effectively discharge the deteriorated toner adhered onto the toner supply roller, by stopping transport of the toner from the first transport path.

In the developing device according to this aspect of the invention, it is preferable that transport of the toner from the first transport path be stopped to discharge the toner within the development chamber to the toner cartridge when a high image quality mode or a cleaning mode is selected before replacement of the toner cartridge. With such a configuration, the high image quality mode in which it is not preferable to use deteriorated toner or the cleaning mode in which image formation is not performed is set as the predetermined condition. As a result, it is possible to refresh the deteriorated toner at a desirable timing. In addition, it is possible to effectively discharge the deteriorated toner adhered onto the toner supply roller, by stopping transport of the toner from the first transport path.

In the developing device according to this aspect of the invention, it is preferable that the first transport unit and the second transport unit be driven separately. With such a configuration, it is possible to select driving of the transport for circulating the toner within the development chamber of driving of the transport for the refresh operation which discharges the deteriorated toner into the toner cartridge.

In the developing device according to this aspect of the invention, it is preferable that a developing roller and a toner supply roller be disposed in the development chamber, and it is also preferable that a driving unit which enables the toner supply roller to rotate forward or reverse be disposed therein. It is possible to select a rotation direction at the time of printing, a rotation direction at the time of refresh operation of the deteriorated toner, or a rotation direction at the time of collection of the deteriorated toner.

According to a sixth aspect of the invention, an image forming apparatus includes: a latent image carrier which is rotatably provided and on which an electrostatic latent image is formed; a developing device which develops the electrostatic latent image with a developer to form a toner image on the latent image carrier; a transfer unit which transfers the toner image on the latent image carrier onto a transfer material; and a fixing unit which fixes the toner image on the transfer material. In the image forming apparatus, the above-mentioned developing device is mounted as the developing device. With such a configuration, it is possible to prevent image deterioration caused by mixing of the new toner with the residual-deteriorated toner.

### BRIEF DESCRIPTION OF THE DRAWINGS

The invention will be described with reference to the accompanying drawings, wherein like numbers reference like elements.

FIG. 1 is a view illustrating a yellow developing unit according to a first embodiment and a second embodiment of the present invention.

FIG. 2 is a perspective view illustrating a first example of FIG. 1.

FIG. 3 is a perspective view illustrating a second example of FIG. 1.

FIG. 4 is a view illustrating the first example of arrangement of an abutting member and a toner supply roller according to the invention.

FIG. 5 is a view illustrating the second example of arrangement of an abutting member and a toner supply roller according to the invention.

FIG. 6 is a view illustrating a yellow developing unit according to a third embodiment of the invention.

FIG. 7 is a view illustrating a first example of a deteriorated toner containing section which is provided in a toner cartridge of FIG. 6.

FIG. 8 is a view illustrating a second example of a deteriorated toner containing section which is provided in a toner cartridge of FIG. 6.

FIG. 9 is a view illustrating a yellow developing unit according to a fourth embodiment of the invention.

FIG. 10 is a perspective view illustrating a first example of FIG. 9.

FIG. 11 is a perspective view illustrating a second example of FIG. 9.

FIG. 12 is a view illustrating a yellow developing unit according to a fifth embodiment of the invention.

FIG. 13 is a perspective view illustrating a first example of FIG. 12.

FIG. 14 is a perspective view illustrating a second example of FIG. 12.

FIG. 15 is a schematic view illustrating an example of an image forming apparatus according to the invention.

FIG. 16 is a schematic view illustrating an example of an image forming station according to the invention.

### DESCRIPTION OF EXEMPLARY EMBODIMENTS

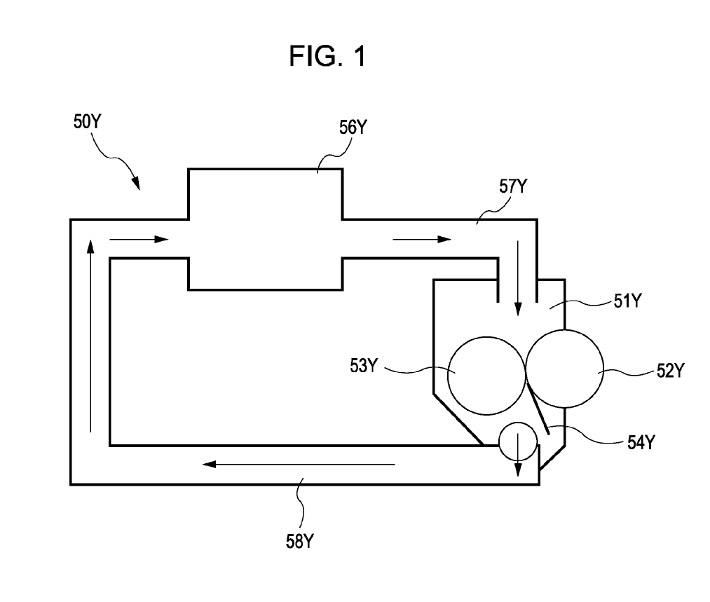

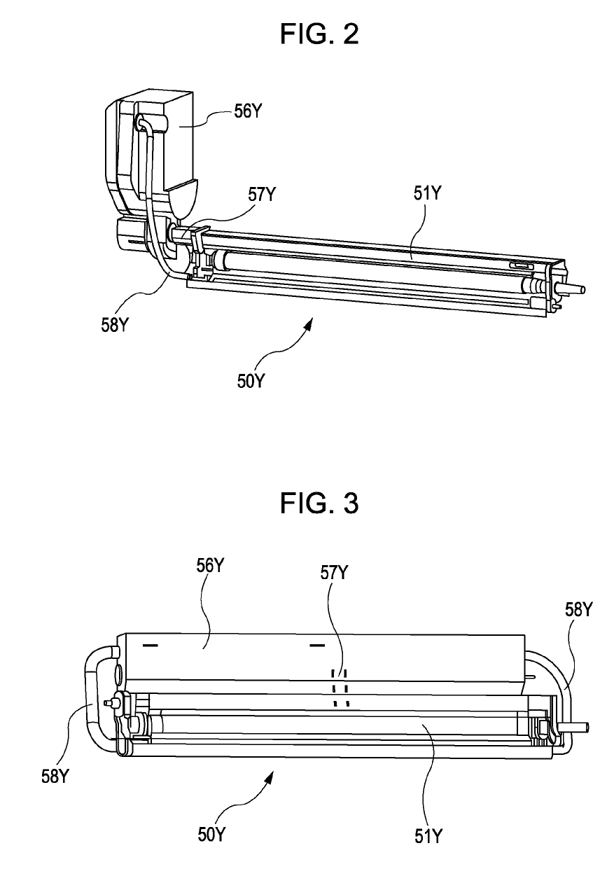

Hereinafter, a first embodiment of the invention will be described with reference to the accompanying drawings. FIG. 1 is a view illustrating a developing unit as an example of a yellow developing unit 50Y for disposing of the residual-deteriorated toner, which causes image deterioration, in the developing chamber. FIG. 2 is a perspective view illustrating a first example of the developing unit 50Y. FIG. 3 is a perspective view illustrating a second example of the developing unit 50Y.

In the developing unit 50Y, sometimes toner within the development chamber 51Y is completely consumed after development is performed for a long time because of a low image occupancy ratio, and development is started by replacing toner cartridge 56Y and supplying new toner to the development chamber 51Y, thereby causing image deterioration. This is because the residual toner within the development chamber 51Y is deteriorated, the residual toner which is deteriorated is mixed with the new toner, and the mixture is used in the development.

For example, the toner deterioration causes the following undesirable effects. Fluidity of toner decreases since an additive such as hydrophobic silica externally added to base toner particles is buried in the base toner particles by the mechanical stress applied to the toner, the number of toner particles with small diameters increases due to crushing of the toner, or a charged amount of the toner at the time of development is in proportion to a particle diameter of toner, and thus the toner particles with small diameters are accumulated in the developing device since development is selectively performed in accordance with a particle diameter of toner. Moreover, fluidity of toner decreases due to the toner particles with small diameters, and aggregated mass of toner is created due to mutual aggregation of toner particles of which fluidity decreases. These factors cause deterioration in image.

In the case of toner particles with small diameters, the charged amount thereof is easily increased excessively and the image force onto a latent image carrier works strongly. Accordingly, adhesion (so-called image fogging) of the toner particles onto a non-image area is observed. Since the toner particles with small diameters tend to be scattered, the toner particles are scattered from an opening and the like of the developing device. This causes internal contamination of the image forming apparatus.

When the fluidity of toner drops, the frictional charging of the toner within the developing device becomes insufficient. As a result, toner with an opposite polarity to a desired charging polarity is generated. The toner with the opposite polarity is also observed as image fogging. In addition, the toner of which charging becomes insufficient due to deterioration of the toner is hard to be carried on the developing roller, and causes a regulation passing failure from a seal portion and a regulation blade of the developing device. Accordingly, the toner makes user's hand dirty at the time of replacement of the developing unit, and causes internal contamination of the image forming apparatus.

Since toner of which the fluidity has lowered or the aggregated mass cannot smoothly pass a contact portion between the developing roller 52Y and the regulation blade 54Y, charging becomes insufficient. Sometimes, this causes image fogging. In addition, the aggregated mass is fused (so-called filming) on a surface of the developing roller 52Y or regulation blade 54Y by the mechanical force and frictional heat in the contact portion between the developing roller 52Y and the regulation blade 54Y. When the aggregated mass is extremely large, the aggregated mass clogs the contact portion. As a result, in the contact portion where filming and the like have occurred, a layer of toner is not formed on the developer roller 52Y, and an image corresponding thereto is observed as white stripes (image missing).

As shown in FIG. 1, a developing unit 50Y includes a replaceable toner cartridge 56Y, a first transport path 57Y which connects a toner cartridge 56Y to a development chamber 51Y, and a second transport path 58Y which connects the development chamber 51Y to the toner cartridge 56Y. The developing unit 50Y shown in FIG. 2 has one first transport path 57Y and one second transport path 58Y. On the other hand, the developing unit 50Y shown in FIG. 3 has the first transport path 57Y connected to the middle of the development chamber 51Y and the transport paths 58Y connected to both ends of the development chamber 51Y. That is, the developing unit 50Y shown in FIG. 3 has two transport paths 58Y.

One end of the first transport path 57Y is connected to an upper portion of the development chamber 51Y in the gravity direction, thereby transporting new toner from the toner cartridge 56Y to the development chamber 51Y. Supply of the toner, which has passed through the first transport path 57Y from the toner cartridge 56Y, to the development chamber 51Y is performed by driving of a first transport unit (not shown), such as a screw conveyor, built in the toner cartridge 56Y. Driving of the first transport unit is ON/OFF controlled.

One end of the second transport path 58Y is connected to a lower portion of the development chamber 51Y in the gravity direction, thereby discharging deteriorated toner from the development chamber 51Y to the toner cartridge 56Y. Discharge of residual-deteriorated toner from the lower side of the development chamber 51Y to the toner cartridge 56Y is executed by driving of a second transport unit (not shown) such as a screw conveyor disposed on the bottom of the development chamber 51Y. Driving of the second transport unit is ON/OFF controlled by a separate driving from the driving of the first transport unit. Discharge of the residual-deteriorated toner within the development chamber 51Y to the toner cartridge 56Y through the second transport path 58Y is performed at the time of replacement of the toner cartridge 56Y. Mixing of the new toner with the residual-deteriorated toner is prevented by separately ON/OFF controlling the driving of the first transport unit for supplying the new toner to the development chamber 51Y through the first transport path 57Y and the driving of second transport unit for discharging the residual-deteriorated toner within the development chamber 51Y to the vacant toner cartridge 56Y through the second transport path 58Y.

By determining the discharge time of the residual-deteriorated toner at the time of replacement of the toner cartridge 56Y, it is possible to periodically discharge the deteriorated toner which remains in the development chamber 51Y. Accordingly, the development chamber 51Y can be refreshed before the residual-deteriorated toner within the development chamber 51Y is extremely deteriorated, and thus it is possible to prevent image deterioration caused by the mixing of the new toner with the residual-deteriorated toner.

The replacement of the toner cartridge 56Y is executed when vacancy of the toner cartridge 56Y is detected by determining that a signal of toner end transmitted from the toner end sensor (not shown) such as a piezoelectric element installed in the development chamber 51Y is valid. Alternatively, the replacement is executed when a signal transmitted from a toner deterioration detection unit such as a sensor for sensing a degree of deterioration of the toner within the development chamber exceeds an allowable range of deterioration of the toner within the development chamber.

In the development chamber 51Y, there are disposed the developing roller 52Y, a toner supply roller 53Y for supplying the toner to the developing roller 52Y, and a regulation blade 54Y for uniformly thinning a layer of the toner on the developing roller 52Y in direct contact with the developing roller 52Y. As a material of the toner supply roller 53Y, polyurethane foam or silicone foam is used. For the toner supply roller 53Y, physical properties that the hardness is low so that the stress against toner is low, permanent pressure distortion is small, and the abrasion resistance of the surface is high are requested. Therefore, it is especially suitable to adopt the polyurethane foam having these physical properties.

Even when the toner end sensor issues the toner end signal to replace the toner cartridge 56Y, the toner remains around the developing roller 52Y and the toner supply roller 53Y within the development chamber 51Y.

In order to effectively discharge the toner remaining in the development chamber 51Y, a driving unit that makes the toner supply roller 53Y rotate forward or reverse is provided in the present embodiment. In the embodiment of the invention, when the developing roller 52Y rotates counterclockwise at the time of printing, the toner supply roller 53Y rotates in the clockwise direction, which is the opposite direction to the rotation direction of the developing roller 52Y, and supplies toner to the developing roller 52Y. When the residual-deteriorated toner is discharged at the time of replacement of the toner cartridge 56Y, the toner supply roller 53Y is made to rotate counterclockwise in order to collect toner adhering on the toner supply roller 53Y. In this case, the developing roller 52Y may be driven to rotate counterclockwise or rotation driving of the developing roller 52Y may be stopped. Furthermore, when the developing roller 52Y rotates counterclockwise at the time of printing, the toner supply roller 53Y may be made to rotate in the same counterclockwise direction as the developing roller 52Y. When the residual-deteriorated toner is discharged at the time of replacement of the toner cartridge 56Y, the toner supply roller 53Y may be made to rotate clockwise.

Moreover, in order to promote the movement of the toner adhering to the toner supply roller 53Y toward the developing roller 52Y, a toner supply roller bias application unit provided separately from the developing roller 52Y is disposed on the toner supply roller 53Y. At the time of discharge of residual-deteriorated toner, the movement of the toner adhering to the toner supply roller 53Y toward the developing roller 52Y becomes easy by applying a larger bias than a bias value applied from the toner supply roller bias application unit to the developing roller. Particularly in this case, discharge of deteriorated toner adhering to a hole portion of the toner supply roller 53Y, which is formed of a soft elastic porous body, is promoted.

In order to drop the toner adhering to the toner supply roller 53Y on the bottom portion of the development chamber 51Y and discharge the toner, an abutting member 59Y comes in direct contact with the toner supply roller 53Y. By making the abutting member 59Y be able to come in direct contact with and separated from the toner supply roller 53Y, the abutting member 59Y may come in direct contact with the toner supply roller 53Y only at the time of discharge of the residual-deteriorated toner, and the abutting member 59Y may separate from the toner supply roller 53Y at the time of printing. When the abutting member 59Y comes in direct contact with the toner supply roller 53Y and drops the toner adhering thereto, the abutting member 59Y is disposed to come in direct contact therewith in a counter direction with respect to the rotation direction of the toner supply roller 53Y.

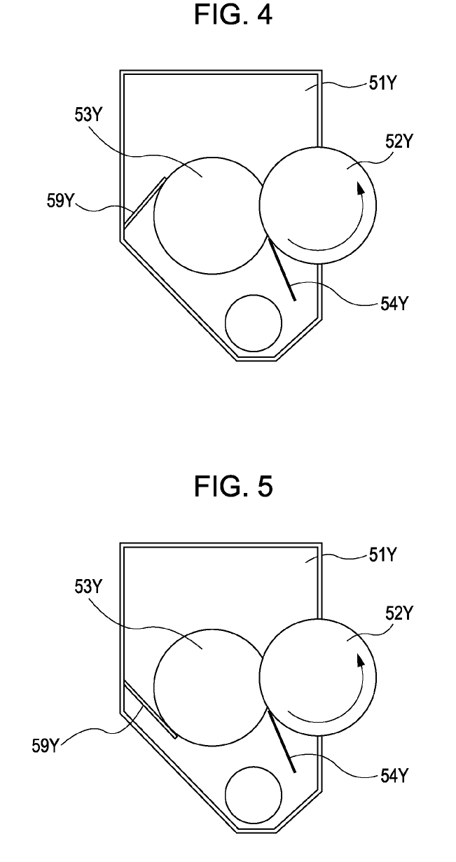

FIG. 4 is views illustrating a first example of arrangement in which the contact direction of the abutting member 59Y to the toner supply roller 53Y is different when the abutting member 59Y is made to be in direct contact with the toner supply roller 53Y. In the case of the arrangement of the abutting member 59Y shown in FIG. 4, the abutting member 59Y comes in contact with the toner supply roller 53Y in the trail direction with respect to the rotation direction of the toner supply roller 53Y and makes a toner layer on the toner supply roller 53Y uniform at the time of printing. In a state shown in FIG. 4, the toner supply roller 53Y rotates in the clockwise direction which is an opposite direction to the rotation direction of the developing roller 52Y at the time of printing. At the time of discharge of the residual-deteriorated toner, the abutting member 59Y comes in contact with the toner supply roller 53Y in a counter direction with respect to the rotation direction of the toner supply roller 53Y and scrapes the toner layer on the toner supply roller 53Y to drop it to the bottom portion of the development chamber 51Y. In the state shown in FIG. 4, the toner supply roller 53Y rotates in the counterclockwise direction which is the same direction as the rotation direction of the developing roller 52Y at the time of discharge of toner.

FIG. 5 is views illustrating a second example of arrangement in which the contact direction of the abutting member 59Y to the toner supply roller 53Y is different when the abutting member 59Y is made to be in direct contact with the toner supply roller 53Y. In the case of the arrangement of the abutting member 59Y shown in FIG. 5, the abutting member 59Y comes in contact with the toner supply roller 53Y in the trail direction with respect to the rotation direction of the toner supply roller 53Y and makes a toner layer on the toner supply roller 53Y uniform at the time of printing. In a state shown in FIG. 5, the toner supply roller 53Y rotates in the counterclockwise direction which is the same direction as the rotation direction of the developing roller 52Y at the time of printing. At the time of discharge of the residual-deteriorated toner, the abutting member 59Y comes in contact with the toner supply roller 53Y in a counter direction with respect to the rotation direction of the toner supply roller 53Y and scrapes the toner layer on the toner supply roller 53Y to drop it to the bottom portion of the development chamber 51Y. In the state shown in FIG. 5, the toner supply roller 53Y rotates in the clockwise direction which is an opposite direction to the rotation direction of the developing roller 52Y at the time of discharge of toner.

The discharge of the residual-deteriorated toner which has passed through the second transport path 58Y by the means of the second transport unit is terminated at the time when the residual-deteriorated toner within the development chamber 51Y is removed. In this case, although the residual-deteriorated toner exists in the second transport path 58Y, the vacant toner cartridge 56Y containing the residual-deteriorated toner is removed, and is replaced with the toner cartridge 56Y containing the new toner. The second transport unit of the second transport path 58Y is not driven until the next toner cartridge 56Y is replaced. As a result, it is possible to shorten the discharge time of the residual-deteriorated toner without mixing of the deteriorated toner with the new toner.

According to the developing device of the embodiment of the invention, it is possible to simplify a structure of the developing unit. In addition, it is possible to discharge the residual-deteriorated toner within the development chamber at a periodic timing, that is, at the time of replacement of the toner 56Y. Therefore, it is possible to dispose of the toner remaining in the development chamber before the toner is extremely deteriorated, and it is possible to largely reduce occurrence of fogging and regulation passing failure caused by mixing with the new toner. Furthermore, it is possible to effectively use the vacant toner cartridge 56Y without being required to provide a separate container for containing the deteriorated toner since the discharged deteriorated toner is housed in the vacant toner cartridge 56Y.

Hereinafter, a second embodiment of the invention will be described with reference with the accompanying drawings. The same members as the first embodiment are referenced by the same reference numerals and signs. A developing device of the second embodiment has the same configuration as the developing device of the first embodiment except that a printing operation is performed while toner is circulated during normal printing. Therefore, the same configuration will be omitted in the following description.

As shown in FIG. 1, a developing unit 50Y includes a replaceable toner cartridge 56Y, a first transport path 57Y which connects a toner cartridge 56Y to a development chamber 51Y, and a second transport path 58Y which connects the development chamber 51Y to the toner cartridge 56Y. The developing unit 50Y shown in FIG. 2 has one first transport path 57Y and one second transport path 58Y. On the other hand, the developing unit 50Y shown in FIG. 3 has the first transport path 57Y connected to the middle of the development chamber 51Y and the transport paths 58Y connected to both ends of the development chamber 51Y. That is, the developing unit 50Y shown in FIG. 3 has two transport paths 58Y.

One end of the first transport path 57Y is connected to an upper portion of the development chamber 51Y in the gravity direction, thereby transporting toner from the toner cartridge 56Y to the development chamber 51Y. Supply of new toner, which has passed through the first transport path 57Y from the toner cartridge 56Y, to the development chamber 51Y is performed by driving of a first transport unit (not shown), such as a screw conveyor, built in the toner cartridge 56Y. Driving of the first transport unit is ON/OFF controlled.

One end of the second transport path 58Y is connected to a lower portion of the development chamber 51Y in the gravity direction, thereby discharging deteriorated toner from the development chamber 51Y to the toner cartridge 56Y. Discharge of toner from the lower side of the development chamber 51Y to the toner cartridge 56Y is executed by driving of a second transport unit (not shown), such as a screw conveyor disposed on the bottom of the development chamber 51Y. Driving of the second transport unit is ON/OFF controlled by a separate driving from the driving of the first transport unit.

In the embodiment, the first transport unit of the first transport path 57Y is driven to supply toner to the development chamber 51Y during normal printing, and the second transport unit of the second transport path 58Y disposed on the bottom of the development chamber 51Y is driven to transport the toner within the development chamber 51Y to the toner cartridge 56Y, thereby performing toner circulation. As described above, during normal printing, the printing operation is performed while the toner is circulated in order of the toner cartridge 56Y→the first transport path 57Y→the development chamber 51Y→the second transport path 58Y→the toner cartridge 56Y.

Since the toner is circulated all the time during printing, the toner is uniformly deteriorated. As a result, it is possible to prevent image deterioration caused in that the toner is extremely deteriorated.

During the time interval until replacement of the toner cartridge 56Y, a refresh operation of the toner within the development chamber 51Y is executed under a predetermined condition. The execution condition of the refresh operation during the time interval until replacement of the toner cartridge 56Y is that printing with a low image occupancy ratio is continuously performed for a predetermined time or more or is continuously performed on a predetermined number or more of sheets. The reason is that the toner within the development chamber 51Y is deteriorated by frictional heat and mechanical force when development is driven for a long time under the state. With such a configuration, it is possible to discharge the deteriorated toner adhered onto the toner supply roller 53Y.

The execution condition of the refresh operation during the time interval until replacement of the toner cartridge 56Y is that a high image quality mode or a cleaning mode is selected. In the high image quality mode, in particular, it is preferred that image deterioration caused by the deteriorated toner, which is adhered onto the toner supply roller 53Y, be prevented. For this reason, the deteriorated toner within the development chamber 51Y including the deteriorated toner adhered onto the toner supply roller 53Y is discharged. In the cleaning mode, an image is not formed. Accordingly, there is no wasted time in image formation by performing the refresh operation of the deteriorated toner within the development chamber 51Y in the cleaning mode.

The refresh operation during the time interval until replacement of the toner cartridge 56Y is performed by the following steps. In the first step, supply of toner from the toner cartridge 56Y to the development chamber 51Y through the first transport path 57Y is stopped. In the second step, the toner within the development chamber 51Y is discharged to the toner cartridge 56Y through the second transport path 58Y. The refresh operation during the time interval until replacement of the toner cartridge 56Y continues until the toner within the development chamber 51Y is discharged, and is stopped in a state where the toner remains in the second transport path 58Y, thereby shortening the time of the toner refresh operation during the time interval until replacement of the toner cartridge 56Y. In addition, it is possible to effectively discharge the deteriorated toner adhered onto the toner supply roller 53Y, by stopping transport of the toner from the first transport path. After the refresh operation, printing is performed by circulating the toner in order of the toner cartridge 56Y, the first transport path 57Y, the development chamber 51Y, the second transport path 58Y, and the toner cartridge 56Y. The refresh operation during the time interval until replacement of the toner cartridge 56Y is not executed when an amount of the toner within the toner cartridge 56Y is small.

The time of replacement of the toner cartridge 56Y is a time when a signal of toner end transmitted from the toner end sensor (not shown) such as a piezoelectric element installed in the development chamber 51Y is valid. Alternatively, the replacement is executed when a signal transmitted from a toner deterioration detection unit such as a sensor for sensing a degree of deterioration of the toner reaches a predetermined value. A refresh operation at the time of replacement of the toner cartridge 56Y is performed by the following steps. In the first step, supply of toner from the toner cartridge 56Y to the development chamber 51Y through the first transport path 57Y is stopped. In the second step, the toner within the development chamber 51Y is discharged to the toner cartridge 56Y through the second transport path 58Y. The refresh operation at the time of replacement of the toner is operable to discharge all the toner within the development chamber 51Y and the second transport path 58Y to the toner cartridge 56Y. In the third step, the toner cartridge 56Y containing the deteriorated toner is removed, and a toner cartridge 56Y containing a new toner is mounted.

In the development chamber 51Y, there are disposed the developing roller 52Y, a toner supply roller 53Y, which is formed of a soft elastic porous body, for supplying the toner to the developing roller 52Y, and a regulation blade 54Y for uniformly thinning a layer of the toner on the developing roller 52Y in direct contact with the developing roller 52Y. As a material of the toner supply roller 53Y, polyurethane foam or silicone foam is used. For the toner supply roller 53Y, physical properties that the hardness is low so that the stress against toner is low, permanent pressure distortion is small, and the abrasion resistance of the surface is high are requested. Therefore, it is especially suitable to adopt the polyurethane foam having these physical properties.

In the refresh operation during the time interval until replacement of the toner cartridge 56Y and the refresh operation at the time of replacement of the toner cartridge 56Y, it is necessary to effectively discharge the toner remaining in the development chamber 51Y. For this reason, toner supply roller 53Y is rotatable forwardly and reversely in the embodiment of the invention. When the developing roller 52Y rotates counterclockwise at the time of printing, the toner supply roller 53Y rotates in the clockwise direction, which is the opposite direction to the rotation direction of the developing roller 52Y, and supplies toner to the developing roller 52Y. When the residual-deteriorated toner is discharged at the time of replacement of the toner cartridge 56Y, the toner supply roller 53Y is made to rotate counterclockwise in order to collect toner adhering on the toner supply roller 53Y. In this case, the developing roller 52Y may be driven to rotate counterclockwise or rotation driving of the developing roller 52Y may be stopped. Furthermore, when the developing roller 52Y rotates counterclockwise at the time of printing, the toner supply roller 53Y may be made to rotate in the same counterclockwise direction as the developing roller 52Y. When the residual-deteriorated toner is discharged at the time of replacement of the toner cartridge 56Y, the toner supply roller 53Y may be made to rotate clockwise.

Moreover, in order to promote the movement of the toner adhering to the toner supply roller 53Y toward the developing roller 52Y, a toner supply roller bias application unit provided separately from the developing roller 52Y is disposed on the toner supply roller 53Y. At the time of discharge of residual-deteriorated toner, the movement of the toner adhering to the toner supply roller 53Y toward the developing roller 52Y becomes easy by applying a larger bias than a bias value applied from the toner supply roller bias application unit to the developing roller 52Y. Particularly in this case, discharge of deteriorated toner adhering to a hole portion of the toner supply roller 53Y, which is formed of a soft elastic porous body, is promoted.

In order to drop the toner adhering to the toner supply roller 53Y on the bottom portion of the development chamber 51Y and discharge the toner, an abutting member 59Y comes in direct contact with the toner supply roller 53Y. By making the abutting member 59Y be able to come in direct contact with and separated from the toner supply roller 53Y, the abutting member 59Y may come in direct contact with the toner supply roller 53Y only at the time of discharge of the residual-deteriorated toner, and the abutting member 59Y may separate from the toner supply roller 53Y at the time of printing. When the abutting member 59Y comes in direct contact with the toner supply roller 53Y and drops the toner adhering thereto, the abutting member 59Y is disposed to come in direct contact therewith in a counter direction with respect to the rotation direction of the toner supply roller 53Y.

FIG. 4 is views illustrating a first example of arrangement in which the contact direction of the abutting member 59Y to the toner supply roller 53Y is different when the abutting member 59Y is made to be in direct contact with the toner supply roller 53Y. In the case of the arrangement of the abutting member 59Y shown in FIG. 4, the abutting member 59Y comes in contact with the toner supply roller 53Y in the trail direction with respect to the rotation direction of the toner supply roller 53Y and makes a toner layer on the toner supply roller 53Y uniform at the time of printing. In a state shown in FIG. 4, the toner supply roller 53Y rotates in the clockwise direction which is an opposite direction to the rotation direction of the developing roller 52Y at the time of printing. At the time of discharge of the residual-deteriorated toner, the abutting member 59Y comes in contact with the toner supply roller 53Y in a counter direction with respect to the rotation direction of the toner supply roller 53Y and scrapes the toner layer on the toner supply roller 53Y to drop it to the bottom portion of the development chamber 51Y. In the state shown in FIG. 4, the toner supply roller 53Y rotates in the counterclockwise direction which is the same direction as the rotation direction of the developing roller 52Y at the time of discharge of toner.

FIG. 5 is views illustrating a second example of arrangement in which the contact direction of the abutting member 59Y to the toner supply roller 53Y is different when the abutting member 59Y is made to be in direct contact with the toner supply roller 53Y. In the case of the arrangement of the abutting member 59Y shown in FIG. 5, the abutting member 59Y comes in contact with the toner supply roller 53Y in the trail direction with respect to the rotation direction of the toner supply roller 53Y and makes a toner layer on the toner supply roller 53Y uniform at the time of printing. In a state shown in FIG. 5, the toner supply roller 53Y rotates in the counterclockwise direction which is the same direction as the rotation direction of the developing roller 52Y at the time of printing. At the time of discharge of the residual-deteriorated toner, the abutting member 59Y comes in contact with the toner supply roller 53Y in a counter direction with respect to the rotation direction of the toner supply roller 53Y and scrapes the toner layer on the toner supply roller 53Y to drop it to the bottom portion of the development chamber 51Y. In the state shown in FIG. 5, the toner supply roller 53Y rotates in the clockwise direction which is an opposite direction to the rotation direction of the developing roller 52Y at the time of discharge of toner.

According to the developing device of the embodiment of the invention, it is possible to simplify a structure of the developing unit. In addition, it is possible to refresh the toner within the development chamber before the toner is extremely deteriorated by executing each of the toner refresh operation during the time interval until replacement of the toner cartridge 56Y and the toner refresh operation at the time of replacement thereof. Further, it is possible to largely reduce occurrence of fogging and regulation passing failure caused by the extremely deteriorated toner. Furthermore, it is possible to effectively use the vacant toner cartridge 56Y without being required to provide a separate container for containing the deteriorated toner since the discharged deteriorated toner is housed in the vacant toner cartridge 56Y.

Hereinafter, a third embodiment of the invention will be described with reference with the accompanying drawings. The same members as the first and second embodiments are referenced by the same reference numerals and signs. A developing device of the third embodiment has the same configuration as the developing device of the first embodiment except that deteriorated toner is discharged to the deteriorated toner containing section under a predetermined condition. Therefore, the same configuration will be omitted in the following description.

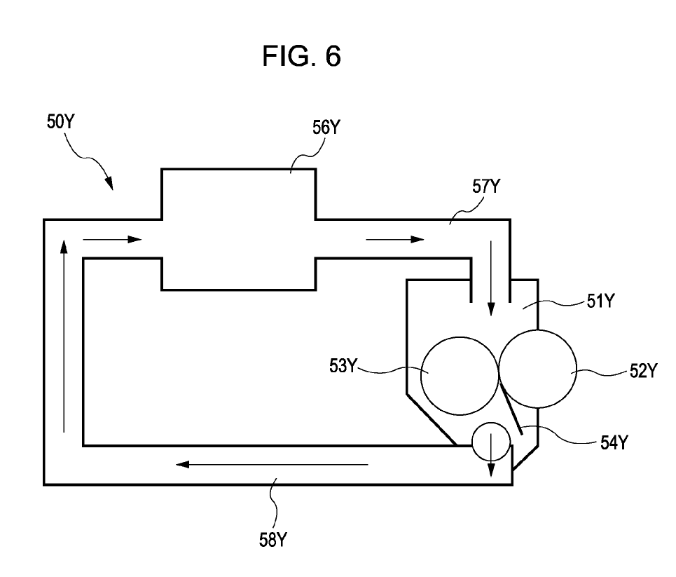

FIG. 6 is a view illustrating a yellow developing unit 50Y as an example of a developing unit for disposing of residual-deteriorated toner, which causes image deterioration, within the development chamber. As shown in FIG. 6, the developing unit 50Y includes a replaceable toner cartridge 56Y, a first transport path 57Y which connects a toner cartridge 56Y to a development chamber 51Y, and a second transport path 58Y which connects the development chamber 51Y to a deteriorated toner collecting section 100 within the toner cartridge 56Y.

One end of the first transport path 57Y is connected to an upper portion of the development chamber 51Y in the gravity direction, thereby transporting new toner from the toner cartridge 56Y to the development chamber 51Y. Supply of the toner, which has passed through the first transport path 57Y from the toner cartridge 56Y, to the development chamber 51Y is performed by driving of a first transport unit (not shown), such as a screw conveyor, built in the toner cartridge 56Y. Driving of the first transport unit is ON/OFF controlled.

One end of the second transport path 58Y is connected to a lower portion of the development chamber 51Y in the gravity direction, thereby discharging deteriorated toner from the development chamber 51Y to the deteriorated toner collecting section 100 separated from a new toner containing section in the toner cartridge 56Y. Discharge of residual-deteriorated toner from the lower side of the development chamber 51Y to the deteriorated toner collecting section within the toner cartridge 56Y is executed by driving of a second transport unit (not shown), such as a screw conveyor disposed on the bottom of the development chamber 51Y. Driving of the second transport unit is ON/OFF controlled by a separate driving from the driving of the first transport unit.

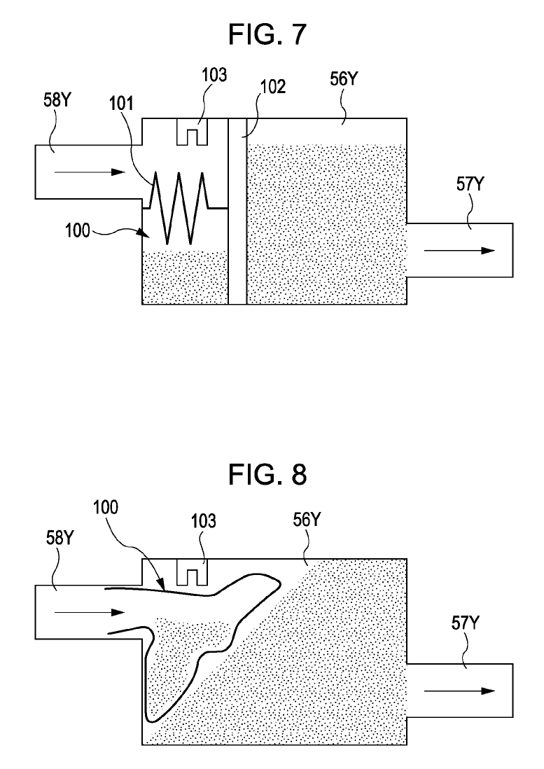

FIG. 7 is a view illustrating a first example of a deteriorated toner containing section 100 which has a variable capacity and is separated from a new toner containing section provided in the toner cartridge 56Y. The deteriorated toner collecting section 100 within the toner cartridge 56Y shown in FIG. 7 has a partition wall 102 urged toward the new toner collecting section by a spring 101, and the partition wall 102 is provided to separate the discharged deteriorated toner from the new toner. The deteriorated toner collecting section 100 is connected with the second transport path 58Y. The deteriorated toner collecting section 100 is moved forward by the spring 101 when the new toner within the new toner collecting section separated by a partition wall 102 is consumed and a capacity of the collecting section decreases. Thus, it is possible to increase a capacity of the deteriorated toner collecting section 100. A vacant capacity sensor 103 is disposed in the deteriorated toner collecting section 100, and is configured to detect a vacant capacity of the deteriorated toner collecting section 100. When it is determined that the vacant capacity can not be secured on the basis of data transmitted from the vacant capacity sensor 103, discharge of the deteriorated toner to the deteriorated toner collecting section 100 within the toner cartridge 56Y is not executed.

FIG. 8 is a view illustrating a second example of a deteriorated toner containing section 100 which has a variable capacity and is separated from the new toner containing section provided in the toner cartridge 56Y. The deteriorated toner collecting section 100 within the toner cartridge 56Y shown in FIG. 8 is formed as a flexible pouch in order to prevent mixing of the new toner with the deteriorated toner. When the new toner within the toner cartridge 56Y is consumed, an expanded space for containing the deteriorated toner can be secured in the deteriorated toner collecting section 100 formed as a flexible pouch. A vacant capacity sensor 103 is disposed in the deteriorated toner collecting section 100, and is configured to detect a vacant capacity of the deteriorated toner collecting section 100. When it is determined that the vacant capacity can not be secured on the basis of data transmitted from the vacant capacity sensor 103, discharge of the deteriorated toner to the deteriorated toner collecting section 100 within the toner cartridge 56Y is not executed.

First, a case where the toner cartridge 56Y is replaced, the case is set as an execution condition of a refresh operation which is performed to refresh the inside of the development chamber 51Y in a way that the second transport unit discharges the residual-deteriorated toner, which had passed through the second transport path 58Y, within the development chamber 51Y to the deteriorated toner collecting section 100 within the toner cartridge 56Y. By determining the execution condition of the refresh operation of the residual-deteriorated toner within the development chamber at the time of replacement of the toner cartridge 56Y, It is possible to periodically dispose of the deteriorated toner which remains in the development chamber 51Y. Therefore, it is possible to refresh the development chamber 51Y before the residual-deteriorated toner within the development chamber 51Y is extremely deteriorated. As a result, it is possible to prevent image deterioration caused by mixing of the new toner with the residual-deteriorated toner. Furthermore, it is possible to maximize a capacity of the deteriorated toner collecting section 100 since the new toner disappears in the toner cartridge 56Y at the time of replacement of the toner cartridge 56Y.

Furthermore, a case where printing (printing of ultra-low duty, for example, 1% duty) with an extremely low image occupancy ratio is continuously performed on a certain number or more of sheets or is continuously performed for a predetermined time or more, the case is set as an execution condition of the refresh operation which discharges the residual-deteriorated toner within the development chamber 51Y to the deteriorated toner collecting section 100 of the toner cartridge 56Y through the second transport path 58Y. The reason is that the toner within the development chamber 51Y is deteriorated by frictional heat and mechanical force when development is driven for a long time under the state.

Further, a case where a high image quality mode or a cleaning mode is selected, the case is set as an execution condition of the refresh operation which discharges the residual-deteriorated toner within the development chamber 51Y to the deteriorated toner collecting section 100 of the toner cartridge 56Y through the second transport path 58Y. In the high image quality mode, it is preferred to use new toner. Therefore, the deteriorated toner within the development chamber 51Y is discharged. In the cleaning mode, an image is not formed. Accordingly, there is no wasted time in image formation by performing the refresh operation of the deteriorated toner within the development chamber 51Y in the cleaning mode.

The discharge of the residual-deteriorated toner which has passed through the second transport path 58Y by the means of the second transport unit is terminated at the time when the residual-deteriorated toner within the development chamber 51Y is removed. In this case, although the residual-deteriorated toner exists in the second transport path 58Y, the residual-deteriorated toner is not mixed with the new toner. As a result, it is possible to shorten the discharge time of the residual-deteriorated toner.

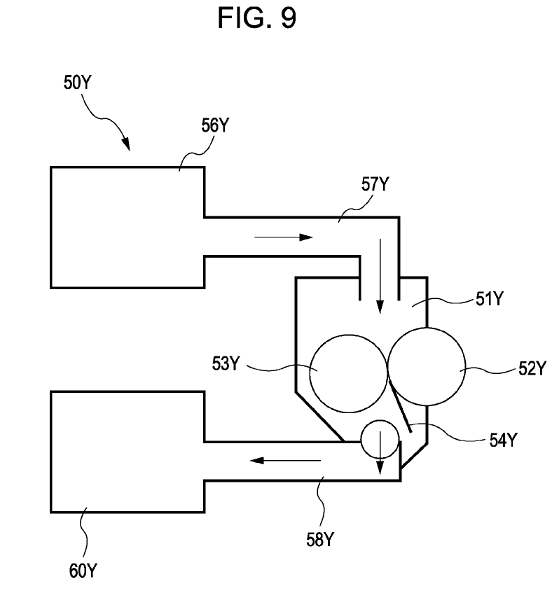

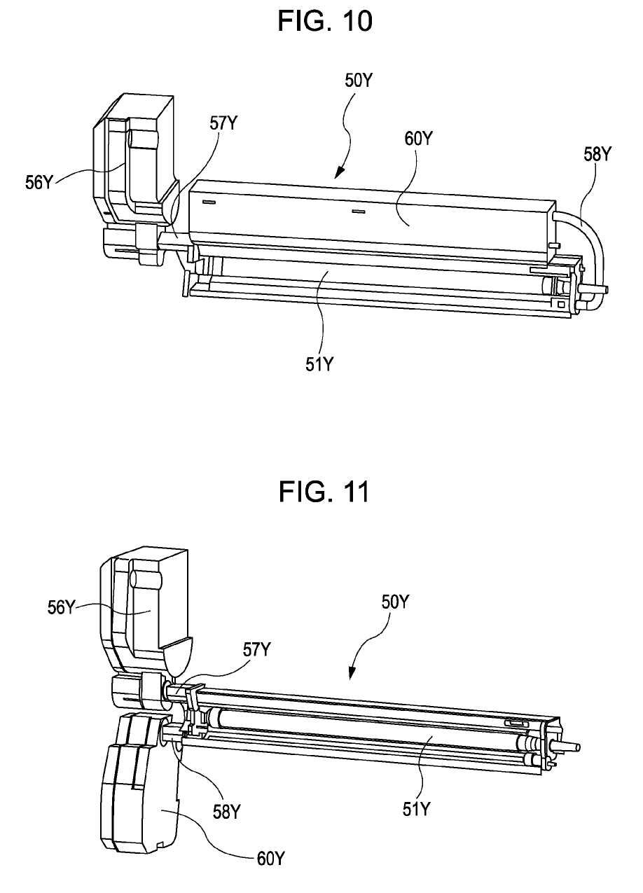

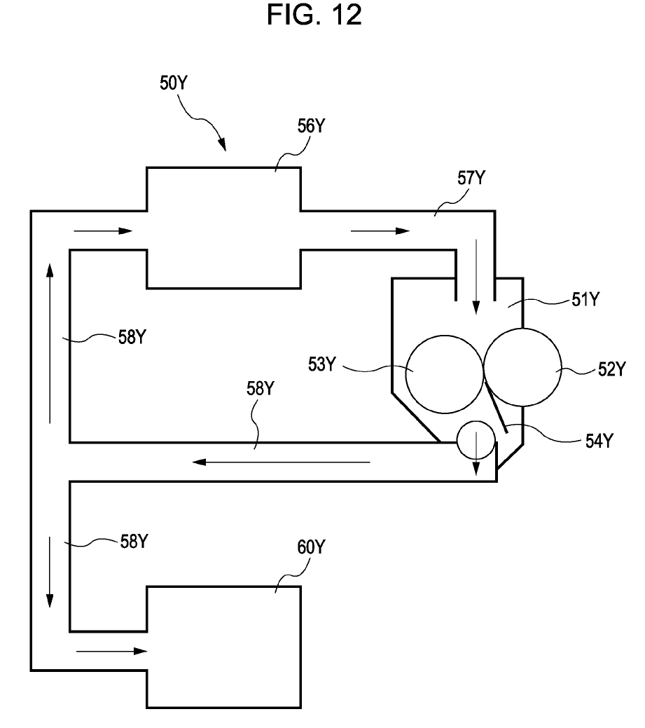

FIG. 9 is a view illustrating a fourth embodiment of a developing unit 50Y for disposing of the residual-deteriorated toner within the development chamber 51Y. FIGS. 10 and 11 are schematic perspective views illustrating the developing unit 50Y according to the embodiment shown in FIG. 9.

The developing unit 50Y according to the embodiment includes a replaceable toner cartridge 56Y, a first transport path 57Y which connects a toner cartridge 56Y to the development chamber 51Y, and a second transport path 58Y which connects the development chamber 51Y to a waste toner bottle 60Y as a deteriorated toner collecting section.

In order to provide the waste toner bottle 60Y, an install space is required in the developing unit 50Y. However, by using the waste toner bottle 60Y rather than the deteriorated toner collecting section 100 within the toner cartridge 56Y, it is possible to secure a larger capacity. As a result, it is possible to discharge the deteriorated toner at any time without any limitation. Execution conditions of the refresh operation which discharges the deteriorated toner within the development chamber 51Y are the same as those of the embodiments shown in FIGS. 6 to 8.

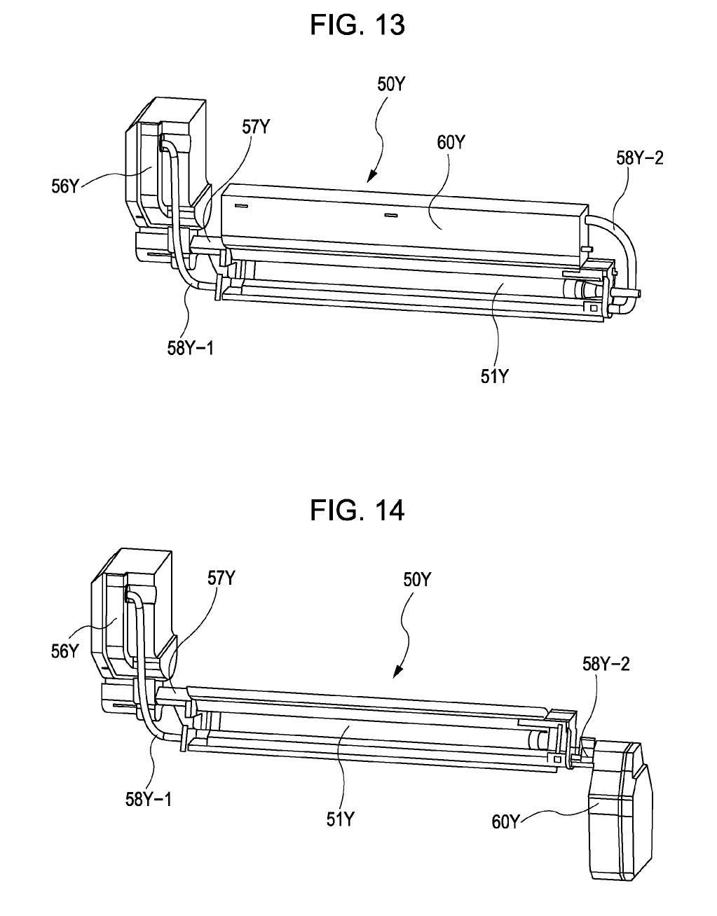

FIG. 12 is a view illustrating a fifth embodiment of the developing unit 50Y for disposing of the residual-deteriorated toner within the development chamber 51Y. FIG. 13 is a perspective view illustrating a first example of the developing unit 50Y of the embodiment shown in FIG. 12. FIG. 14 is a perspective view illustrating a second example of the developing unit 50Y of the embodiment shown in FIG. 12.

The developing unit 50Y of the embodiment includes a replaceable toner cartridge 56Y, a first transport path 57Y which connects a toner cartridge 56Y to a development chamber 51Y, and a second transport path 58Y which connects the development chamber 51Y to a waste toner bottle 60Y and a deteriorated toner collecting section 100 within the toner cartridge 56Y. The second transport path 58Y has a branch portion for connecting two deteriorated toner collecting sections, that is, the waste toner bottle 60Y and the deteriorated toner collecting section 100 within the toner cartridge 56Y. A switching valve (not shown) for discharging the deteriorated toner within the development chamber 51Y to any one of the waste toner bottle 60Y and the deteriorated toner collecting section 100 within the toner cartridge 56Y is disposed in the branch portion. As shown in FIGS. 13 and 14, it is possible to individually provide a second transport path 58Y-1 for connecting the development chamber 51Y to the deteriorated toner collecting section 100 within the toner cartridge 56Y and a second transport path 58Y-2 for connecting the development chamber 51Y and the waste toner bottle 60Y.

In the embodiment, the deteriorated toner collecting section 100 within the toner cartridge 56Y is firstly used as a place for discharging the deteriorated toner within the development chamber 51Y. With such a configuration, it is possible to decrease a capacity of the waste toner bottle 60Y. Execution conditions of the refresh operation which discharges the deteriorated toner within the development chamber 51Y are the same as those of the embodiments shown in FIGS. 6 to 8.

In the development chamber 51Y, there are disposed the developing roller 52Y, a toner supply roller 53Y, which is formed of a soft elastic porous body, for supplying the toner to the developing roller 52Y, and a regulation blade 54Y for uniformly thinning a layer of the toner on the developing roller 52Y in direct contact with the developing roller 52Y. When the deteriorated toner within the development chamber 51Y is discharged, toner which remains around the toner supply roller 53Y and the developing roller 52Y is also required to be discharged. As a material of the toner supply roller 53Y, polyurethane foam or silicone foam is used. For the toner supply roller 53Y, physical properties that the hardness is low so that the stress against toner is low, permanent pressure distortion is small, and the abrasion resistance of the surface is high are requested. Therefore, it is especially suitable to adopt the polyurethane foam having these physical properties.

In order to effectively discharge the toner remaining in the development chamber 51Y, the toner supply roller 53Y is provided to be rotatable forwardly and reversely. In the embodiment of the invention, when the developing roller 52Y rotates counterclockwise at the time of printing, the toner supply roller 53Y rotates in the clockwise direction, which is the opposite direction to the rotation direction of the developing roller 52Y, and supplies toner to the developing roller 52Y. When the residual-deteriorated toner is discharged at the time of replacement of the toner cartridge 56Y, the toner supply roller 53Y is made to rotate counterclockwise in order to collect toner adhering on the toner supply roller 53Y. In this case, the developing roller 52Y may be driven to rotate counterclockwise or rotation driving of the developing roller 52Y may be stopped. Furthermore, when the developing roller 52Y rotates counterclockwise at the time of printing, the toner supply roller 53Y may be made to rotate in the same counterclockwise direction as the developing roller 52Y. When the residual-deteriorated toner is discharged at the time of replacement of the toner cartridge 56Y, the toner supply roller 53Y may be made to rotate clockwise.

Moreover, in order to promote the movement of the toner adhering to the toner supply roller 53Y toward the developing roller 52Y, a toner supply roller bias application unit provided separately from the developing roller 52Y is disposed on the toner supply roller 53Y. At the time of discharge of residual-deteriorated toner, the movement of the toner adhering to the toner supply roller 53Y toward the developing roller 52Y becomes easy by applying a larger bias than a bias value applied from the toner supply roller bias application unit to the developing roller 52Y. Particularly in this case, discharge of deteriorated toner adhering to a hole portion of the toner supply roller 53Y, which is formed of a soft elastic porous body, is promoted.

In order to drop the toner adhering to the toner supply roller 53Y on the bottom portion of the development chamber 51Y and discharge the toner, a plate-like abutting member comes in direct contact with the toner supply roller 53Y. By making the plate-like abutting member be able to come in direct contact with and separated from the toner supply roller 53Y, the plate-like abutting member may come in direct contact with the toner supply roller 53Y only at the time of discharge of the residual-deteriorated toner, and the plate-like abutting member may separate from the toner supply roller 53Y at the time of printing. When the abutting member 59Y comes in direct contact with the toner supply roller 53Y and drops the toner adhering thereto, the abutting member 59Y is disposed to come in direct contact therewith in a counter direction with respect to the rotation direction of the toner supply roller 53Y.

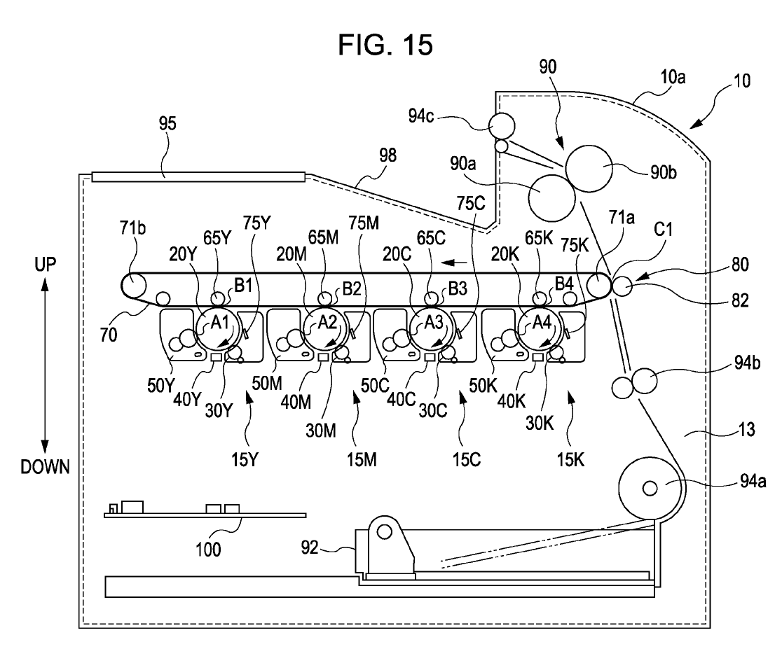

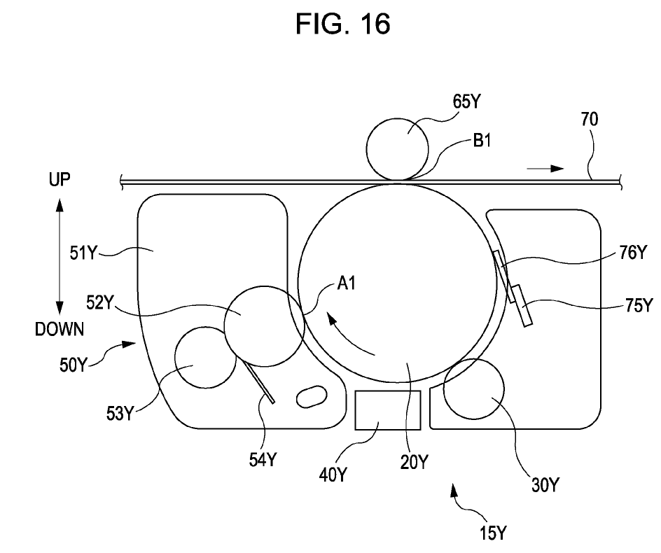

FIG. 15 is a schematic view illustrating an example of an image forming apparatus having the developing device according to the invention. FIG. 16 is a schematic view illustrating an example of a yellow image forming station of FIG. 15.

As shown in FIG. 15, the image forming apparatus 10 includes four image forming stations 15 (Y, M, C, and K), an intermediate transfer belt 70, a secondary transfer unit 80, a fixing unit 90, a display unit 95 that serves as an informing unit for a user and is formed of a liquid crystal panel, and a control unit 100 that controls these units to thereby control an operation as an image forming apparatus.

Each of the image forming stations 15 (Y, M, C, and K) has a function of forming an image with toner of yellow (Y), magenta (M), cyan (C), and black (K). Since the configurations of the image forming stations 15 (Y, M, C, and K) are the same, the image forming station 15Y will now be described.

As shown in FIG. 16, the image forming station 15Y has a charging unit 30Y, an exposure unit 40Y, a developing unit 50Y, a primary transfer portion By, and a photoconductor cleaning unit 75Y along the rotation direction of a photoconductor 20Y as an example of an image carrier.

The photoconductor 20Y has a cylindrical base and a photosensitive layer formed on an outer peripheral surface of the base and is rotatable about a central shaft. In the embodiment, the photoconductor 20Y rotates clockwise as indicated by the arrow.

The charging unit 30Y is a device for electrically charging the photoconductor 20Y. The exposure unit 40Y forms an electrostatic latent image on the electrically charged photoconductor 20Y by irradiating a laser beam.

The exposure unit 40Y has a semiconductor laser, a polygon mirror, an F-θ lens, and the like. The exposure unit 40Y irradiates onto the electrically charged photoconductor 20Y a laser beam modulated on the basis of an image signal input from a host computer, which is not shown, such as a personal computer and a word processor.

The developing unit 50Y is a device for developing the latent image formed on the photoconductor 20Y using toner of yellow (Y). In the developing unit 50Y, a developing roller 52Y and a toner supply roller 53Y are disposed in a development chamber 51Y supplied with new toner from a replaceable toner cartridge 56Y. A regulation blade 54Y is in contact with the developing roller 52Y in order to make toner on the developing roller 52Y thin.

The primary transfer portion B1 transfers the yellow toner image formed on the photoconductor 20Y onto the intermediate transfer belt 70. In case where the toner of four colors sequentially overlaps to be transferred by four primary transfer portions B1, B2, B3, and B4, a full-color toner image is formed on the intermediate transfer belt 70.

The intermediate transfer belt 70 is an endless belt stretched over a belt driving roller 71a and a driven roller 71b and is driven to rotate in a state of being in contact with the photoconductor 20 (Y, M, C, and K).

The secondary transfer unit 80 is a device for transferring a monochrome toner image or a full-color toner image formed on the intermediate transfer belt 70 onto a transfer material such as a paper, a film, and a cloth.

The fixing unit 90 is configured to include a fixing roller 90a and a pressure roller 90b. The fixing unit 90 is a device for fixing the monochrome toner image or the full-color toner image transferred onto the transfer material by fusion to thereby form a permanent image.

The photoconductor cleaning unit 75Y has a photoconductor cleaning blade 76Y which is in contact with a surface of the photoconductor 20Y and is formed of rubber. The photoconductor cleaning unit 75Y is a device for removing the toner, which remains on the photoconductor 20Y after the toner image is transferred onto the intermediate transfer belt 70 by the primary transfer portion By, by scraping using the photoconductor cleaning blade 76Y.

Next, an operation of the image forming apparatus 10 configured as described above will be described.

First, when an image signal and a control signal from a host computer which is not shown are input to a main controller of the image forming apparatus through an interface, the photoconductor 20Y, the developing roller provided in the developing unit 50Y, the intermediate transfer belt 70, and the like rotate by control of a unit controller based on the command from the main controller. The photoconductor 20Y is sequentially charged at the charging position by the charging unit 30Y while the photoconductor 20Y rotates.

An electrically charged region of the photoconductor 20Y reaches the exposure position with rotation of the photoconductor 20Y, and a latent image corresponding to image information of yellow Y is formed in the region by the exposure unit 40Y.

The latent image formed on the photoconductor 20Y reaches the developing position with rotation of the photoconductor 20Y and is developed by the developing unit 50Y. As a result, a toner image is formed on the photoconductor 20Y.

The toner image formed on the photoconductor 20Y reaches the position of the primary transfer portion B1 with rotation of the photoconductor 20Y, and is transferred onto the intermediate transfer belt 70 by the primary transfer unit. At this time, a primary transfer voltage which has an opposite polarity to the charging polarity of toner is applied to the primary transfer unit. As a result, the toner images of four colors formed on the photoconductors 20 (Y, M, C, and K) are transferred onto the intermediate transfer belt 70 so as to overlap each other, and a full-color toner image is formed on the intermediate transfer belt 70.

The intermediate transfer belt 70 is driven when a driving force from a belt driving unit, such as a motor, is transmitted through the belt driving roller 71a.

The full-color toner image formed on the intermediate transfer belt 70 is transferred onto a transfer material, such as paper, by the secondary transfer unit 80. The transfer material is transported from a paper feed tray to the secondary transfer unit 80 through a paper supply roller 94a and a resist roller 94b.

The full-color liquid developer image transferred onto the transfer material is heated and pressed by the fixing unit 90 to be fused on the transfer material. After passing the fixing unit 90, the transfer material is discharged by a paper discharge roller 94c.

On the other hand, the photoconductor 20 (Y, M, C, and K) is discharged by a discharge unit (not shown) after passing the positions of the primary transfer portions B1, B2, B3, and B4. Then, the toner adhered onto the surface of the photoconductor 20 (Y, M, C, and K) is scraped by the photoconductor cleaning blade 76 (Y, M, C, and K) supported on the photoconductor cleaning unit 75 (Y, M, C, and K) in order to prepare for electric charging for forming a next latent image. The scraped toner is collected in a residual toner collecting portion provided in the photoconductor cleaning unit 75 (Y, M, C, and K).

An intermediate transfer belt cleaning device (not shown) is provided on a side of the intermediate transfer belt 70 facing the driven roller 71b after secondary transfer and cleans the intermediate transfer belt 70 after secondary transfer.

In addition, the above explanation has been made on the basis of an example of the intermediate transfer method using the intermediate transfer belt, but a direct transfer type image forming apparatus may also be used.

The developing device and the image forming apparatus according to the embodiment of the invention have been described on the basis of the principles and examples thereof, but the invention is not limited to the examples, and may be modified in various forms.

What is claimed is:

1. A developing device comprising:
a replaceable toner cartridge;
a development chamber;
a first transport path which connects the toner cartridge to the development chamber;
a first transport unit which transports toner from the toner cartridge to the development chamber through the first transport path;
a second transport path which connects the development chamber to the toner cartridge; and
a second transport unit which discharges the toner within the development chamber to the toner cartridge through the second transport path at the time of replacement of the toner cartridge.

2. The developing device according to claim 1, wherein the first transport unit and the second transport unit are driven separately.

3. The developing device according to claim 1, wherein the second transport unit is driven only at the time of replacement of the toner cartridge.

4. The developing device according to claim 3, wherein the second transport unit is driven until the toner within the development chamber reaches the bottom of the development chamber.

5. The developing device according to claim 1, wherein a developing roller and a toner supply roller are disposed in the development chamber, and a driving unit which enables the toner supply roller to rotate forward or reverse is disposed therein.

6. An image forming apparatus comprising:
a latent image carrier which is rotatably provided and on which an electrostatic latent image is formed;
a developing device which develops the electrostatic latent image with a developer to form a toner image on the latent image carrier;
a transfer unit which transfers the toner image on the latent image carrier onto a transfer material; and
a fixing unit which fixes the toner image on the transfer material,
wherein the developing device according to claim 1 is mounted as the developing device.

7. A developing device comprising:
a replaceable toner cartridge;
a development chamber;
a first transport path which connects the toner cartridge to the development chamber;
a first transport unit which transports toner from the toner cartridge to the development chamber through the first transport path;
a second transport path which connects the development chamber to the toner cartridge; and
a second transport unit which transports the toner from the development chamber to the toner cartridge through the second transport path,
wherein the toner is circulated by driving the first and second transport units, and
wherein all deteriorated toner within the development chamber and the second transport path is discharged to the toner cartridge at the time of replacement of the toner cartridge.

8. The developing device according to claim 7, wherein transport of the toner from the first transport path is stopped to discharge the toner within the development chamber to the toner cartridge when printing with a low image occupancy ratio is continuously performed for a predetermined time or more or is continuously performed on a predetermined number or more of sheets before replacement of the toner cartridge.

9. The developing device according to claim 7, wherein transport of the toner from the first transport path is stopped to discharge the toner within the development chamber to the toner cartridge when a high image quality mode or a cleaning mode is selected before replacement of the toner cartridge.

10. The developing device according to claim 7, wherein the first transport unit and the second transport unit are driven separately.

11. The developing device according to claim 7, wherein a developing roller and a toner supply roller are disposed in the development chamber, and a driving unit which enables the toner supply roller to rotate forward or reverse is disposed therein.

12. An image forming apparatus comprising:
a latent image carrier which is rotatably provided and on which an electrostatic latent image is formed;
a developing device which develops the electrostatic latent image with a developer to form a toner image on the latent image carrier;
a transfer unit which transfers the toner image on the latent image carrier onto a transfer material; and
a fixing unit which fixes the toner image on the transfer material,
wherein the developing device according to claim 7 is mounted as the developing device.

13. A developing device comprising:
a replaceable toner cartridge;
a development chamber;
a first transport path which connects the toner cartridge to the development chamber;
a first transport unit which transports new toner from the toner cartridge to the development chamber through the first transport path;
a second transport path which connects the development chamber to a deteriorated toner collecting section; and
a second transport unit which discharges the toner within the development chamber to the deteriorated toner collecting section through the second transport path under a predetermined condition.

14. The developing device according to claim 13, wherein the predetermined condition is that the toner cartridge is replaced.

15. The developing device according to claim 13, wherein the predetermined condition is that printing with a low image occupancy ratio is continuously performed for a predetermined time or more or is continuously performed on a predetermined number or more of sheets.

16. The developing device according to claim 13, wherein the predetermined condition is that a high image quality mode or a cleaning mode is selected.

17. The developing device according to claim 13, wherein the deteriorated toner collecting section is formed as a variable capacity space separated from a new toner containing section in the toner cartridge.

18. The developing device according to claim 13, wherein the deteriorated toner collecting section is formed as a waste toner bottle.

19. The developing device according to claim 17, wherein the second transport path is divided into a transport path for connecting to the deteriorated toner collecting section within the toner cartridge and a transport path for connecting to the waste toner bottle.

20. An image forming apparatus comprising:
a latent image carrier which is rotatably provided and on which an electrostatic latent image is formed;
a developing device which develops the electrostatic latent image with a developer to form a toner image on the latent image carrier;
a transfer unit which transfers the toner image on the latent image carrier onto a transfer material; and
a fixing unit which fixes the toner image on the transfer material,
wherein the developing device according to claim 13 is mounted as the developing device.
